(19) United States
(12) Patent Application Publication
(10) Pub. No.: US 2002/0129852 A1
(43) Pub. Date: Sep. 19, 2002

(54) Positive response sealed diaphragm anti-siphon valve

(76) Inventor: Joseph Nemshick, Huntington Beach, CA (US)

Correspondence Address: STETINA BRUNDA GARRED & BRUCKER, 75 ENTERPRISE, SUITE 250, ALISO VIEJO, CA, 92656, US

(21) Appl. No.: 09/810,750

(22) Filed: Mar. 16, 2001

(51) Int. Cl. F16K 24/00

(52) U.S. Cl. 137/217

(57) ABSTRACT

An anti-siphon valve providing positive initiation and cessation of liquid flow there through during liquid transfer operations. The valve includes an inlet port for receiving liquid and an outlet port for delivering liquid. A vent port leads to the outlet port, while an air flow controller situated within the vent port prohibits air flow during liquid flow and permits air flow into the outlet port during liquid non-flow, thereby producing a vacuum break upon liquid non-flow. The air flow controller preferably is a vent valve which is pressure sensitive to close the otherwise-open vent port in response to pressure from the liquid flowing through the outlet port.

### CROSS REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

This invention relates in general to anti-siphon valves, and in particular to an anti-siphon valve having a positive response sealed diaphragm vacuum breaker to actuate during flow and non-flow conditions through the valve.

The transfer of liquid from one site to another through appropriate transfer conduits is a commonplace requirement in many operations. Concurrent with such transfers is the need to control liquid flow through the conduits by especially being able to positively begin and end liquid movement. This control typically is accomplished with various valves situated along a conduit and of appropriate construction to achieve a desired end result. One such valve-type, which typically is located at a terminus of a conduit, is an anti-siphon delivery valve that functions to both regulate liquid flow through the valve and to atmospherically vent the outlet port of the valve upon no-flow conditions to provide a vacuum break down-line of the valve.

Because of the criticality of anti-siphon valves, it is important that the vacuum break occasioned by these valves be consistently controlled. More particularly, upon initiation of flow through the valve, the vacuum break must be closed to prevent liquid from splashing outward from the vent passage. However, once the outlet port is closed by the valve closure, the vent port in communication with the outlet port must open to permit air entry and vacuum beak to the outlet port. A major closure problem can occur in present anti-siphon valves, however, because typical valve closures comprise float devices that are supposed to move into place at the opening of the outlet port when liquid flow through the anti-siphon valve is to be stopped. Specifically, while such floats perform properly most of the time, they generally do not perform properly all of the time, tending to instead stick in either an open or closed placement position.

In view of the importance of positive flow control at generally all times, it is apparent that an anti-siphon valve that assures flow control is needed. Accordingly, a primary object of the present invention is to provide an anti-siphon valve wherein a positive vent port seal of a vent port in communication with an outlet port of the valve provides positive sealing-interaction upon liquid flow-cessation through the valve.

Another object of the present invention is to provide an anti-siphon valve wherein an air flow controller situated within the vent port permits air flow into the outlet port automatically upon liquid-flow cessation.

These and other objects of the present invention will become apparent throughout the description thereof which now follows.

### BRIEF SUMMARY OF THE INVENTION

The present invention is an anti-siphon valve that provides positive initiation and cessation of liquid flow there through during liquid transfer operations. The valve includes an inlet port for receiving liquid and an outlet port for delivering liquid, with the outlet port having an entrance thereto and an exit therefrom such that liquid can flow there through from the entrance to the exit. A valve diaphragm seal which is preferably solenoid controlled is disposed at the entrance to the outlet port for opening and closing the entrance upon command. A vent port leads from an exterior location to the outlet port, while an air flow controller situated within the vent port prohibits air flow through the vent port into the outlet port during liquid flow through the outlet port and permits air flow into the outlet port during liquid non-flow, thereby producing a vacuum break upon liquid non-flow. The air flow controller preferably is a vent valve which closes the vent port in response to presence of liquid flowing through the outlet port and for opening the vent port in response to liquid non-flow through the outlet port. The preferred vent valve is pressure sensitive to close the vent port in response to pressure from the liquid flowing through the outlet port. The innovative employment of an air flow controller within the vent port produces an anti-siphon valve that effectively controls and assures positive regulation of liquid flow initiation and cessation upon command through timely instant air entry into the outlet port for immediate vacuum-break action. Because of this construction, the valve is especially, but non-limitedly, useful in marine applications.

### BRIEF DESCRIPTION OF THE DRAWINGS

An illustrative and presently preferred embodiment of the invention is shown in the accompanying drawings in which:

FIG. 1 is an exploded perspective view of an anti-siphon valve; and

FIG. 2 is a side elevation view in section of the anti-siphon valve of FIG. 1 in an assembled state.

### DETAILED DESCRIPTION OF THE PREFERRED EMBODIMENT

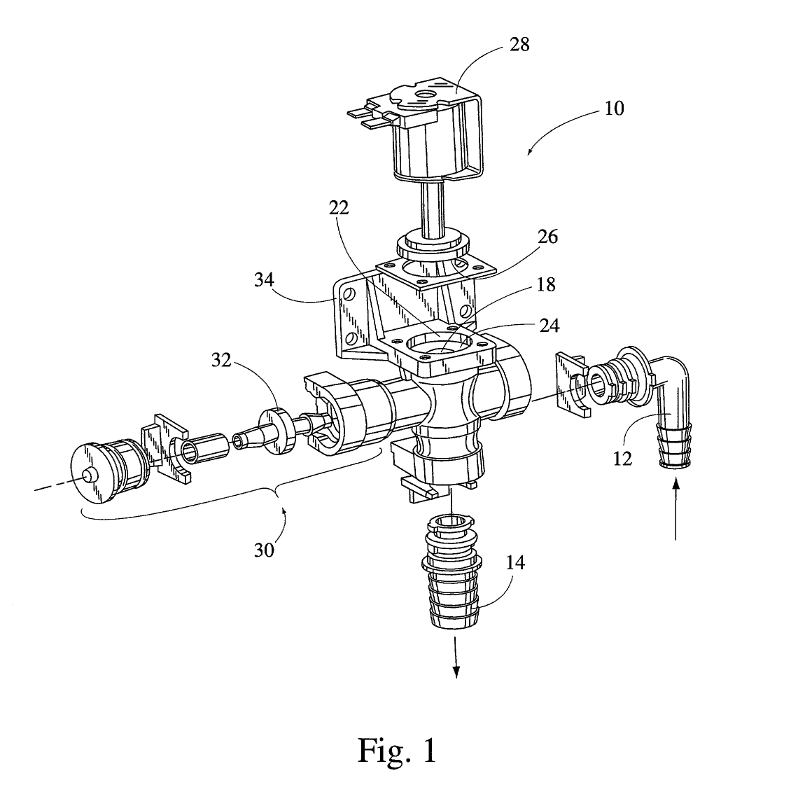

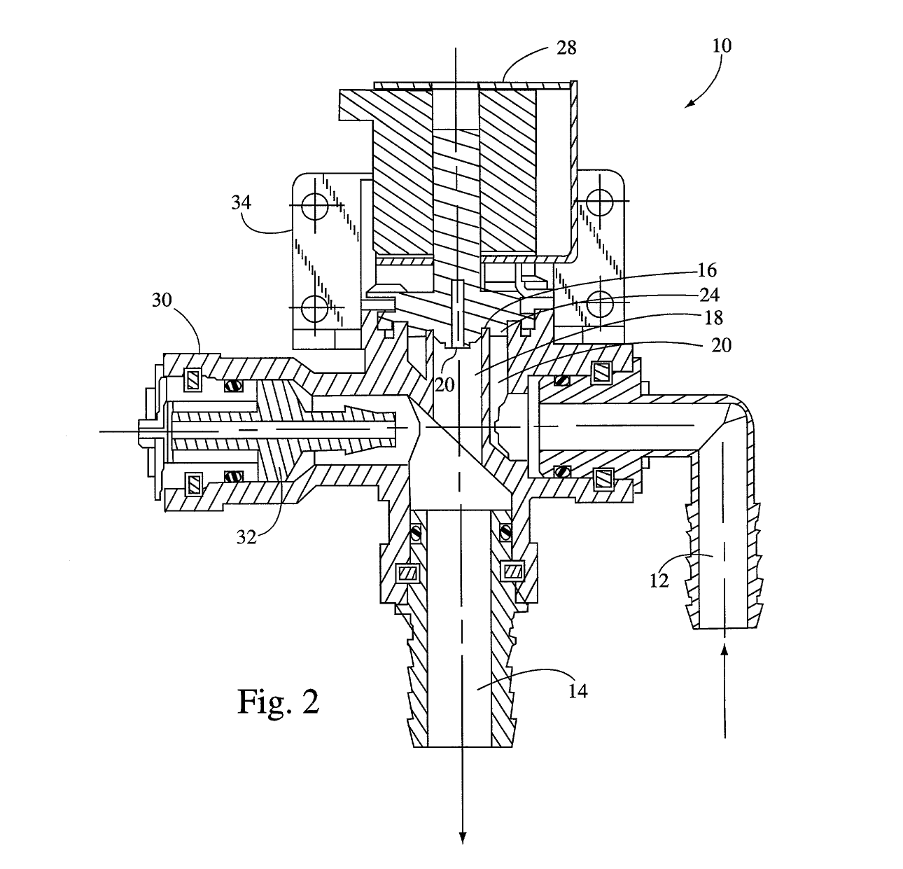

Referring to FIGS. 1 and 2, an anti-siphon valve 10 is shown. The valve 10 has an inlet port 12 for receiving liquid and an outlet port 14 for delivering liquid. The outlet port 14 is coaxially constructed at one end 16 thereof as an inner tube 18 with an end entrance 20 thereto and an outer tube 22 extending beyond the inner tube 18 at the one end 16 to form an inlet cavity or chamber 24 surrounding the entrance 20. The inlet port 12 is in communication with the chamber 24 for receiving liquid entering the inlet port 12. A valve diaphragm seal 26 operated by a standard solenoid 28 is disposed at the entrance 20 to the inner tube 18 of the outlet port 14 for opening and closing the entrance 20 upon command. When the valve seal 26 opens the entrance 20, liquid received in the outer tube 22 from the inlet port 12 and residing in the chamber 24 enters the entrance 20 to thereafter flow through the inner tube 22 to exit the outlet port 14.

A vent port 30 leads from the exterior environment to the inner tube 22 portion of the outlet port 14. Disposed within the vent port 30 is a vent valve 32 such as that non-limitedly exemplified in the medical-grade valve manufactured by Ark-Plas Products, Flippin, Ark., 72634, Part No/19CV0025NN. The vent valve 32 is responsive to pressure created by liquid flowing within the inner tube 22 such that when liquid is there flowing, the vent valve 32 is forced outwardly to close the vent port 30. Conversely, when liquid flow through the inner tube 22 ceases, the vent valve 32 returns inwardly to permit air entry through the vent port 30 and a resulting immediate down-line vacuum break.

In operation, the anti-siphon valve 10 can be mounted at its site of operation using the mounting bracket 34. Liquid is made to flow into the inlet port 12 for delivery to the outer tube 20 and ultimate disposition to the chamber 24 formed about the entrance 20 to the inner tube 18 and available upon withdrawal of the diaphragm seal 26. Upon such withdrawal upon solenoid activation and opening of the entrance 20 to the inner tube 18 of the outlet port 14, the liquid flows into the entrance 20 for delivery from the outlet port 14 as the vent valve 32 within the vent port 30 moves outwardly because of liquid flow pressure to block air flow. When liquid introduction from the inlet port 12 ceases, the diaphragm seal 26 returns to its initial position for closing the entrance 20 to the inner tube 18 while the vent valve 32 within the vent port 30 immediately returns inwardly and opens the vent port 30 to cause a vacuum break. Because the vent valve 32 instantaneously and without float-type hesitation or sticking responds, immediate and positive vacuum breaks in response to liquid-flow status occurs to create optimal operational functionality.

While an illustrative and presently preferred embodiment of the invention has been described in detail herein, it is to be understood that the inventive concepts may be otherwise variously embodied and employed and that the appended claims are intended to be construed to include such variations except insofar as limited by prior art.

What is claimed is:

1. An anti-siphon valve comprising:
a) an inlet port for receiving liquid;
b) an outlet port for delivering liquid, said outlet port having an entrance thereto and an exit therefrom, whereby liquid can flow there through entering at the entrance and being discharged at the exit;
c) a valve diaphragm seal disposed at the entrance to the outlet port for opening and closing said entrance, whereby liquid enters the entrance to the outlet port when the valve seal opens said entrance;
d) a vent port leading from an exterior location to the outlet port; and
e) an air flow controller disposed within the vent port for closing the vent port during liquid flow through the outlet port and opening the vent port during liquid non-flow through said outlet port.

2. An anti-siphon valve as claimed in claim 1 wherein the airflow controller is a vent valve for closing the vent port in response to presence of liquid flowing through the outlet port and for opening the vent port in response to liquid non-flow through the outlet port.

3. An anti-siphon valve as claimed in claim 2 wherein the vent valve is pressure sensitive to close the vent port in response to pressure from the liquid flowing through the outlet port and to open the vent port during liquid non-flow through said outlet port.

4. An anti-siphon valve comprising:
a) an inlet port for receiving liquid;
b) an outlet port for delivering liquid, said outlet port having an entrance thereto and an exit therefrom, whereby liquid can flow there through entering at the entrance and being discharged at the exit;
c) a chamber generally surrounding the entrance to the outlet port for accepting liquid received by the inlet port;
d) a valve diaphragm seal disposed at the entrance to the outlet port for opening and closing said entrance, whereby liquid from the chamber enters the entrance to the outlet port when the valve seal opens said entrance;
e) a vent port leading from an exterior location to the outlet port; and
f) an air flow controller disposed within the vent port for closing the vent port during liquid flow through the outlet port and opening the vent port during liquid non-flow through said outlet port.

5. An anti-siphon valve as claimed in claim 4 wherein the airflow controller is a vent valve for closing the vent port in response to presence of liquid flowing through the outlet port and for opening the vent port in response to liquid non-flow through the outlet port.

6. An anti-siphon valve as claimed in claim 5 wherein the vent valve is pressure sensitive to close the vent port in response to pressure from the liquid flowing through the outlet port and to open the vent port during liquid non-flow through said outlet port.

7. An anti-siphon valve comprising:
a) an inlet port for receiving liquid;
b) an outlet port for delivering liquid, said outlet port coaxially constructed at one end thereof as an inner tube with an end entrance thereto whereby liquid flowing there through exits from the outlet port, and an outer tube at said one end and extending beyond the inner tube at said end entrance thereto for accepting liquid received by the inlet port, with said inlet port leading to the outer tube for transferring liquid thereto;
c) a valve diaphragm seal disposed at the inner tube entrance for opening and closing said entrance, whereby liquid from the outer tube as transferred thereto from the inlet port enters the end entrance to the inner tube when the valve seal opens said entrance;
d) a vent port leading from an exterior location to the inner tube; and
e) an air flow controller disposed within the vent port for closing the vent port during liquid flow through the inner tube and opening the vent port during liquid non-flow through said inner tube.

8. An anti-siphon valve as claimed in claim 7 wherein the airflow controller is a vent valve for closing the vent port in response to presence of liquid flowing through the inner tube and for opening the vent port in response to liquid non-flow through the inner tube.

9. An anti-siphon valve as claimed in claim 8 wherein the vent valve is pressure sensitive to close the vent port in response to pressure from the liquid flowing through the inner tube and to open the vent port during liquid non-flow through said inner tube.

10. An anti-siphon valve comprising:
a) an inlet port for receiving liquid;
b) an outlet port for delivering liquid, said outlet port having an entrance thereto and an exit therefrom, whereby liquid can flow there through entering at the entrance and being discharged at the exit;
c) a vent port leading from an exterior location to the outlet port; and
d) an air flow controller disposed within the vent port for closing the vent port during liquid flow through the outlet port and opening the vent port during liquid non-flow through said outlet port.

11. An anti-siphon valve as claimed in claim 10 wherein the airflow controller is a vent valve for closing the vent port in response to presence of liquid flowing through the outlet port and for opening the vent port in response to liquid non-flow through the outlet port.

12. An anti-siphon valve as claimed in claim 11 wherein the vent valve is pressure sensitive to close the vent port in response to pressure from the liquid flowing through the outlet port and to open the vent port during liquid non-flow through said outlet port.
